(19) United States
(12) Patent Application Publication
(10) Pub. No.: US 2006/0165020 A1
(43) Pub. Date: Jul. 27, 2006

(54) Audio conference system

(76) Inventor: Allen Schultz, Aurora, CO (US)

Correspondence Address: HOLLAND & HART, LLP, P.O BOX 8749, DENVER, CO, 80201, US

(21) Appl. No.: 10/996,542

(22) Filed: Nov. 24, 2004

(51) Int. Cl. H04B 3/20; H04J 3/10; H04J 15/00; H04J 1/12

(52) U.S. Cl. 370/286; 370/201

(57) ABSTRACT

An audio conference system is provided that allows at least one non-standard telephone to be connected to an audio conference environment. The audio conference system includes a telecommunication device and an interface between the telecommunication device and the audio conference room. The interface includes a side tone canceller. The side tone canceller cancels side tones allowing the plain audio signal from the non-standard telephone handset to be routed to the speakers of audio conference system. Moreover, the interface allows telephone conferencing a number of non-standard telephones.

### FIELD OF THE INVENTION

The present invention relates to telecommunications and, more particularly, providing systems and methods to allow non-standard telephone signals to be connected to audio conference rooms.

### BACKGROUND OF THE INVENTION

Audio conferencing allows individuals in one acoustic environment, such as a first room, speak to individuals in a second acoustic environment, such as a second room. Referring to FIG. 1, a simple audio conference system 100 is shown. Audio conference system 100 has a first room 102 and a second room 104 remote from first room 102. First room 102 and second room 104 would have one or more microphones 106 and one or more speakers 108, although for convenience the figure only shows one microphone 106 and speaker 108 in each room. Conventionally, first room 102 is connected to second room 104 using the plain old telephone system (POTS) 110. Microphones 106 and speakers 108 are conventionally coupled to POTS 110 using hybrids 112. Connecting microphones 106 and speakers 108 to POTS 110 using hybrids 112 is conventional and well known in the art; therefore, it will not be further explained herein.

Each microphone 106 typically contains an acoustic echo canceller (AEC) 114. AEC 114 cancels echoes or cross talk that occurs between speakers 108 and microphones 106 in any given acoustical environment. Basically, microphone 106 picks up audio information from speaker 108 that is unwanted. AEC 114 samples the audio signal input to speaker 108 and uses that signal to cancel the cross talk or echo from speaker 108. Operation of AEC 114 is also well known in the art and will not be further explained herein. AEC 114 can be implemented as a hardware solution, a software solution, embedded on a microchip using, for example, firmware, or the like.

Referring now to FIG. 2, a conventional secure telephone system 200 is shown and described. Secure telephone system comprises a first secure telephone 202 and a second secure telephone 204 remote from telephone 202. Each secure telephone 202 and 204 contain a microphone 106 and speaker 108 in the handset 202h and 204h, respectively. First secure telephone 202 and second secure telephone 204 are connected using POTS 110. When using secure telephones, an individual speaks into secure telephone 202, for example. The secure telephone encrypts the audio signal and couples the audio signal to POTS 110. POTS 110 routes the encrypted audio signal to secure telephone 204. Secure telephone decouples the audio signal and decrypts the signal such that the audio can be heard using speaker 108 associated with secure telephone 204.

FIG. 3 shows a communication system 300 where an individual on a secure telephone 302 wishes to communication with a plurality of people in a secure room 304, such as, for example, a command center such as Norad or the like. Using conventional audio conference systems, such as those described in connection with FIG. 1, audio signals from secure telephone 302 are routed as encrypted signals to speaker 108, but because the audio signal from secure telephone 302 is encrypted, the plurality of people in secure room 304 cannot understand the individual on secure telephone 302. Further, audio transmitted from secure room 304 is never encrypted. The individual using secure telephone 302 would not understand the audio as secure telephone 302 would attempt to decrypt an un-encrypted audio signal. For an individual on secure telephone 302 to communicate with a plurality of people in secure room 304, a second secure telephone 306 needs to be installed in room 304. Typically, one of the plurality of people in secure room 304 needs to act as an interface between the individual and the plurality of people.

Thus, it would be desirable to provide improved systems, methods, and apparatuses to allow an individual on a secure telephone to communication with a plurality of people in a secure room.

### SUMMARY OF THE INVENTION

To attain the advantages and in accordance with the purpose of the invention, as embodied and broadly described herein, an audio conference apparatus is provided. The audio conference apparatus comprises a telecommunications device that has an incoming transmission port to receive a non-standard telecommunication incoming transmission. The device converts the non-standard telecommunication incoming transmission to an incoming audio signal. A side tone canceller is coupled to the telecommunications device and to a speaker of the audio conference system. The side tone canceller receives the incoming audio signal and supplies a processed audio signal to the speaker. The side tone canceller including a feedback coupled to the processed audio signal to cancel the side tone. The telecommunication device also comprises an outgoing transmission port to receive at least one return audio signal from the audio conference system and convert the at least one return audio signal to at least one non-standard telecommunication outgoing transmission.

The present invention also provides apparatuses to allow teleconferencing non-standard telecommunication signals. The apparatus to provide non-standard telecommunication signal conferencing comprises at least one non-standard telecommunication device coupled to a corresponding telecommunication network. The at least one non-standard telecommunication device receives non-standard telecommunication incoming signals and converts the non-standard telecommunication incoming signals to incoming audio signals. Another telecommunication device is coupled to a corresponding telecommunication network to receive telecommunication incoming signals and converts the telecommunication incoming signals to incoming audio signals. A processor having a plurality of inputs connected to the one non-standard telecommunication device and the another telecommunication device to receive incoming audio signals. The processor also comprises a plurality of outputs and is capable of generating outgoing audio signals that the non-standard telecommunication device receives, converts and transmits over the corresponding telecommunication network. The another telecommunication device similarly receives the generated outgoing audio signals, converts and transmits the outgoing audio signals over the corresponding telecommunication network.

The foregoing and other features, utilities and advantages of the invention will be apparent from the following more particular description of a preferred embodiment of the invention as illustrated in the accompanying drawings.

### BRIEF DESCRIPTION OF THE DRAWING

The accompanying drawings, which are incorporated in and constitute a part of this specification, illustrate embodiments of the present invention, and together with the description, serve to explain the principles thereof. Like items in the drawings are referred to using the same numerical reference.

FIG. 1 is a functional block diagram of a conventional hands free audio conference system;

FIG. 2 is a functional block diagram of a conventional secure telephone system;

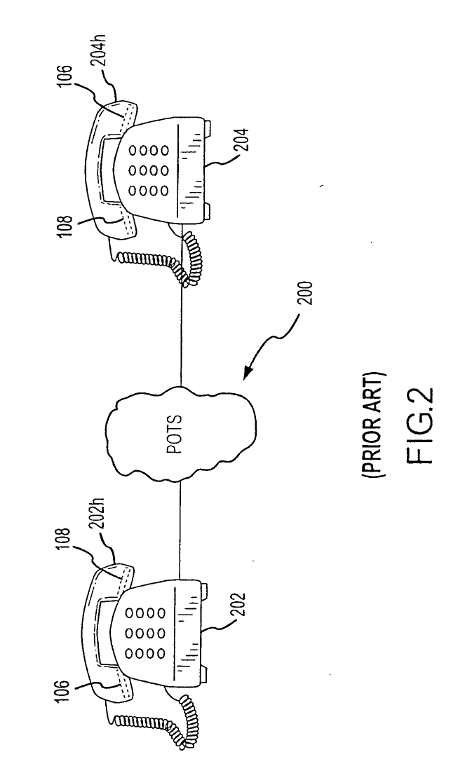

FIG. 3 is a functional block diagram of a conventional secure telephone system operated in a secure room capable of conventional hands free operation;

FIG. 4 is a functional block diagram of an interface consistent with an embodiment of the present invention;

FIG. 5 is a functional block diagram of an interface consistent with an embodiment of the present invention;

FIGS. 6-8 are functional block diagrams of an interface consistent with an embodiment of the present invention using various non-standard telecommunication inputs;

FIG. 9 is a functional block diagram of a secure telephone conference system consistent with an embodiment of the present invention; and

FIG. 10 is a functional block diagram of an interface consistent with an embodiment of the present invention designed to operate with standard audio conference pre-wired equipment.

### DETAILED DESCRIPTION

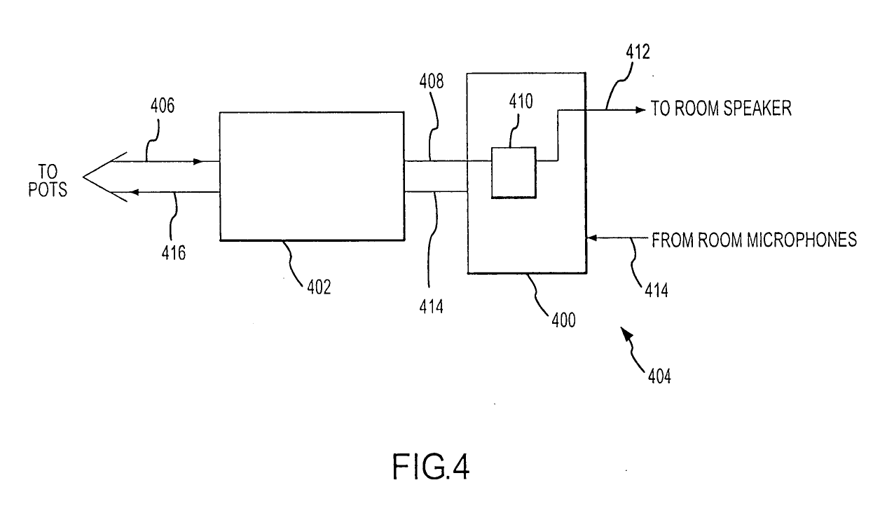

The present invention relates to audio conference systems. As described below in relation to FIGS. 4-10, the present invention has been described more the most part in connection with secure or encrypted telephones. However, on reading the disclosure, one of ordinary skill in the are will now recognize that the present invention could be adapted to function with other communication protocols, such as, for example, standard telephone communication protocols, encrypted or secure telephone communication protocols, cellular telephone communication protocols, satellite telephone communication protocols, Voice over Internet communication protocols, and the like.

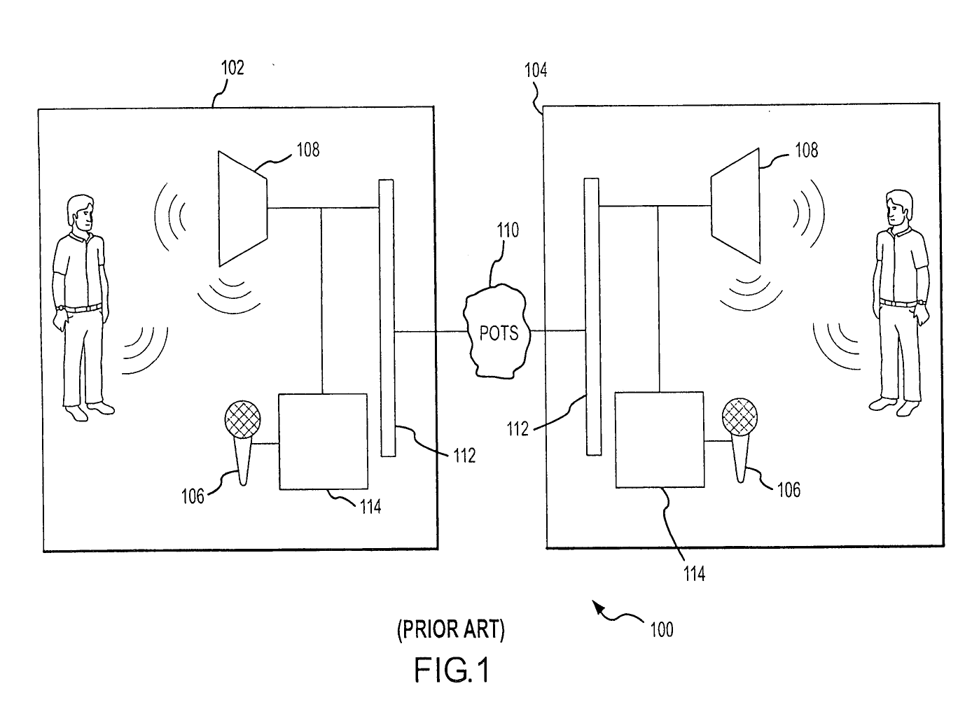

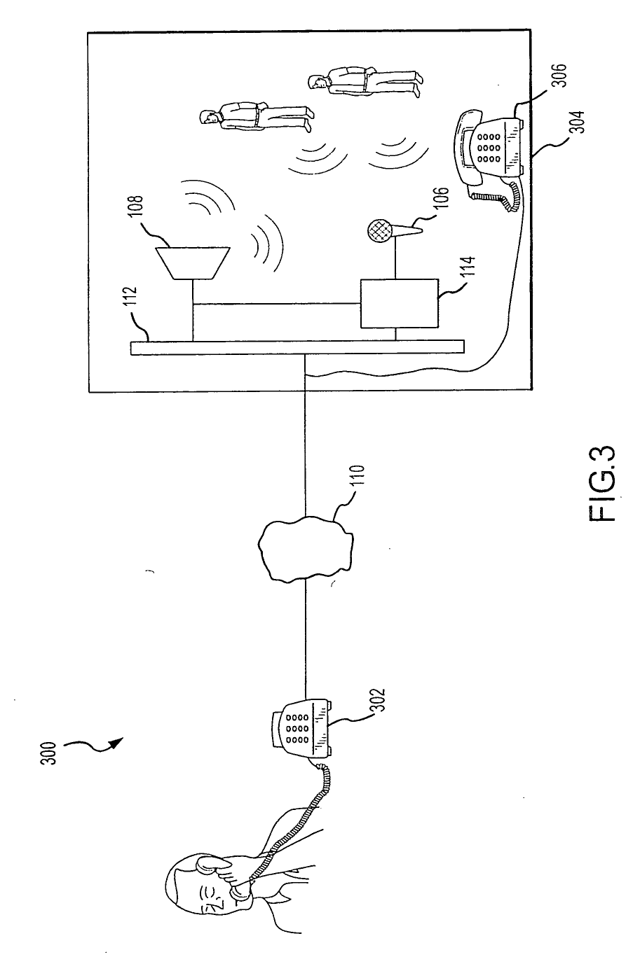

Referring now to FIG. 4, a functional block diagram of an interface 400 to connect a secure telephone 402 to the speaker 108 and microphone 106 of an audio conference room 404. Audio conference room is used generically herein to mean a defined acoustic environment. Further, secure telephone is used generically and can mean either a secure telephone, generally known in the art as a crypto phone, or an independent interface to the telecommunication transmission medium, which in this case is the plain old telephone system sending signals over a public switched telephone network. The rooms can occupy the same living space or be completely across the world from each other. Secure telephone 402 receives an incoming secure audio signal 406 (sometimes referred to as a “non-standard telecommunication incoming signal”) from a remote secure telephone, such as first secure telephone 302 (FIG. 3). Secure telephone 402 decouples and decrypts incoming secure audio signal 406 into a plain audio signal 408 (plain audio signal and audio signal are used interchangeably herein) that is input to interface 400. Interface 400 contains at least a side tone canceller 410. Side tone canceller 410 cancels the side tones and routes a processed audio signal 412 to the room speaker(s), such as speakers 108. Side tone canceller 410 operates similar to an acoustic echo canceller, and is also generally know in the art and will not be further explained herein. Side tone canceller 410 can be implemented as a hardware solution, a software solution, embedded in a chip or chip set, using, for example, firmware, or the like as a matter of design choice. A return audio signal 414 is received at interface 400 as well. Return audio signal 414 has been processed by AEC 114 (FIG. 1). Return audio signal 414 is input to interface 400. Return audio signal 414 does not need to be preprocessed by interface 400 so interface 400 routes return audio signal 414 to secure telephone 402. Secure telephone encrypts the return audio signal 414 and couples it into an outgoing secure audio signal 416 for transmission over the plain old telephone system. Interface 400 can be remote from secure telephone 402 as shown or incorporated into secure telephone 402 as a matter of design choice. Further, interface 400 can be incorporated into a conventional audio system, such as, for example, system 100 described above, also as a matter of design choice. Interface 400 can preprocess return audio signal 414 in conventional manners as a matter of design choice. As one of ordinary skill in the art would now recognize, interface 400 may plug into a telephone between the telephone base and handset.

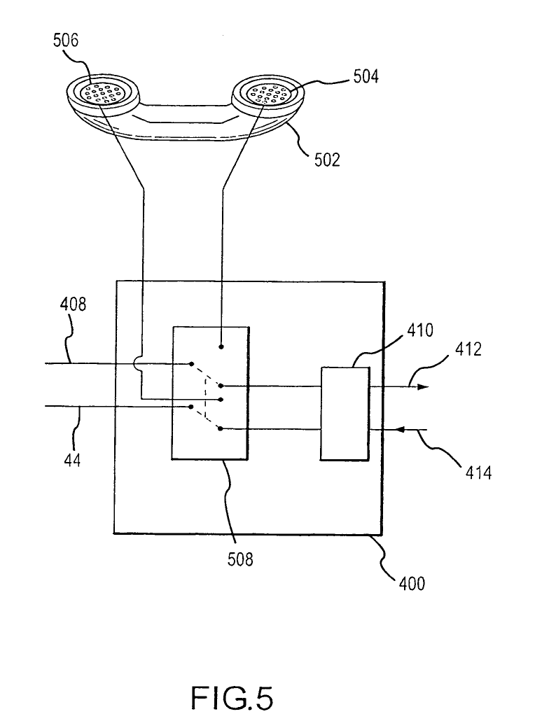

FIG. 4 shows secure telephone 402 being used without a handset 502 (FIG. 5). However, as shown in FIG. 5, interface 400 can operate with a connection to handset 502. While plain audio signal 408 can be routed directly to speaker 504 of handset 502 and return audio signal 414 can be routed directly from microphone 506 of handset 502, it is preferable to incorporate a switch 508 in interface 400. Switch 508 allows a user or operator to elect whether secure telephone 402 is connected to the audio conference system, such as system 100, or to handset 502. Switch 508 can be any conventional switch, such as, for example, a conventional toggle switch, but is preferably a switch that has an identifiable failure position, such as, for example, an optical switch, a magnetic switch, or the like. For example, if an optical switch was used, the off or non powered position of the switch could be set to default to the handset such that the audio conference was only enabled when power was supplied to the system, or vise versa. Of course, switch 508 is optional and the handset could either be removed, as shown in FIG. 4, or always in circuit, as desired.

As mentioned above, interface 400 (with or without switch 508) can be implemented directly into a secure telephone (or a conventional telephone). Thus, using conventional methods, a telephone with interface 400 could be designed to generate dial tone and other control signals necessary to place calls over the public switched telephone network.

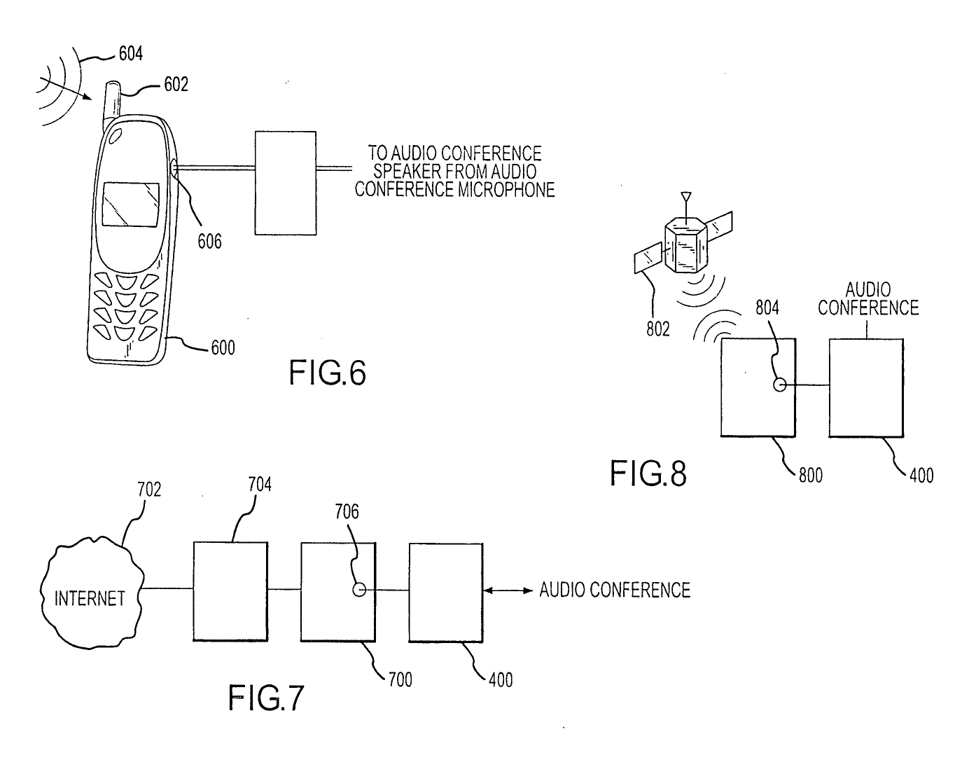

As one of ordinary skill in the art will know recognize, the present invention provides a method of integrating non-standard telecommunications input with standard audio conferencing systems. The present invention uses the term non-standard telecommunications input to means input originating from something other than a conventional telephone connected to the plain old telephone system supplying conventional signals at conventional telephone wall jacks. Other signals are generally referred to as non-standard telecommunication signals, which include, for example, a secure telephone signal at a convention wall jack, a VoIP signal over a network, a cellular signal over a wireless network, or the like. For example, as shown in FIG. 4, incoming secure audio signal 406 and outgoing secure audio signal 416 are processed to be transmitted over POTS 110, but the signals are encrypted signals making them non-standard signals that would not normally be received at a conventional telephone wall jack. FIGS. 6-8 show other exemplary telecommunication systems that can be connected to conventional audio systems using the present invention. FIG. 6 shows a conventional cellular telephone 600. Conventional cellular telephone 600 has an antenna 602 to received cellular audio signals 604. Cellular telephone 600 also includes a handset jack 606. To connect cellular telephone 600 to an audio conference system, interface 400 would connect to hand set jack 606, sometimes referred to as the earpiece/microphone jack in the art. Similarly, FIG. 7 shows a conventional VoIP telephone 700. VoIP telephone 700 receives a telecommunication signal over the internet 702 using conventional VoIP protocols. A local processor 704 may be installed between VoIP telephone 700 and internet 702 depending on the VoIP telephone 700 used. VoIP telehphone 700 includes a handset jack 706. Interface 400 could connect to jack 706 and provide an interface between VoIP telephone 700 and an audio conference system. FIG. 8 shows a satellite telephone 800. Satellite telephone 800 receives telecommunication protocols from a satellite 802 and has a handset jack 804. Interface 400 connected to jack 804 provides the interface between satellite telephone 800 and an audio conference system. While the secure telephone, cellular telephone, VoIP telephone, and satellite telephone are four exemplary non-standard telecommunication protocols, they should be considered exemplary and non-limiting examples.

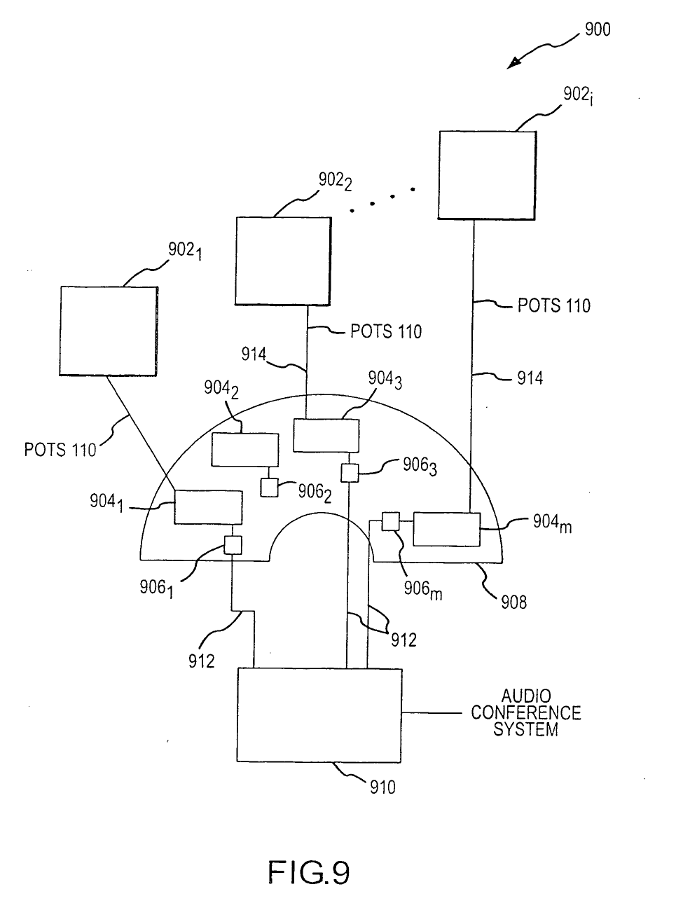

Referring to FIG. 9, a non-standard telecommunications input telephone conference system 900 is shown. Telephone conference 900 may be used in conjunction with an audio conference system, such as the one described in connection with FIG. 4, but is described with respect to telephone conferencing a plurality of remote secure telephones 902 for convenience. While system 900 could be used for an number of standard and non-standard telecommunications inputs, the system is particularly useful for secure telephones due in part to the unique encryption each secure telephone requires. System 900 would comprises a plurality of local secure telephones 904 (or at least the encrypt, decrypt, and coupling functionality if not the actual telephone.). Each of the local secure telephones includes a conference connect switch 906. Conference connect switch 906 provides a mechanism to allow a conference operator to connect any given secure telephone to the conference; however, conference connect switch 906 is optional and a remote secure telephone 902 may connect to the conference simply by dialing into the corresponding local secure telephone 904. Generally, the plurality of local secure telephones 904 correspond to the maximum number of remote secure telephones 902 expected to conference, however, there does not need to be a one-to-one correspondence. Further, while shown in an operational console 908 for system 900, local secure telephones 904 may be separate telephones arranged on a table, wall, or the like as a matter of design choice. The connections between local secure telephones 904 and remote secure telephones 902 can be implemented using POTS 110.

Each local secure telephone 904 is subsequently connected to conference system 910, which could be also include connecting to an audio conference system 400. Conference system 910 operates largely as a signal router, but can perform processing as desired. In operation, an individual speaking into remote secure telephone 902₁ has the audio encrypted and coupled to POTS 110. POTS 110 transmits the signal to local secure telephone 904₁. Local secure telephone decrypts and decouples the audio signal to a plain audio signal 912 that is patched to conference system 910 via conference connect switch 906₁. Plain audio signal 912 is than routed by conference system 910 to for example local secure telephone 904₃ and 904ₘ via the appropriate conference connect switch 906. Local secure telephones encrypt and couple plain audio signal 912 into a secure transmission 914 over POTS 110. The secure transmission 914 is received by remote secure telephones 902₂ and 902ᵢ, in this example, so the individual on remote secure telephone 902₁ and teleconference with individuals on remote secure telephones 902₂ and 902ᵢ. Plain audio signal 912 is not returned to the original speaker by conference system 910.

Referring specifically to FIG. 9, telephones 902₁ and telephone 904₁, telephones 902₂ and telephone 904₃, and telephones 902ᵢ and telephone 904ₘ need to be compatible devices. However, telephones 902₁ and telephone 904₁ may be use different telecommunication protocols than telephones 902₂ and telephone 904₃ which may use different telecommunication protocols than telephones 902ᵢ and telephone 904ₘ. For example, a secure telephone could be teleconferenced with a cellular telephone or even a conventional telephone.

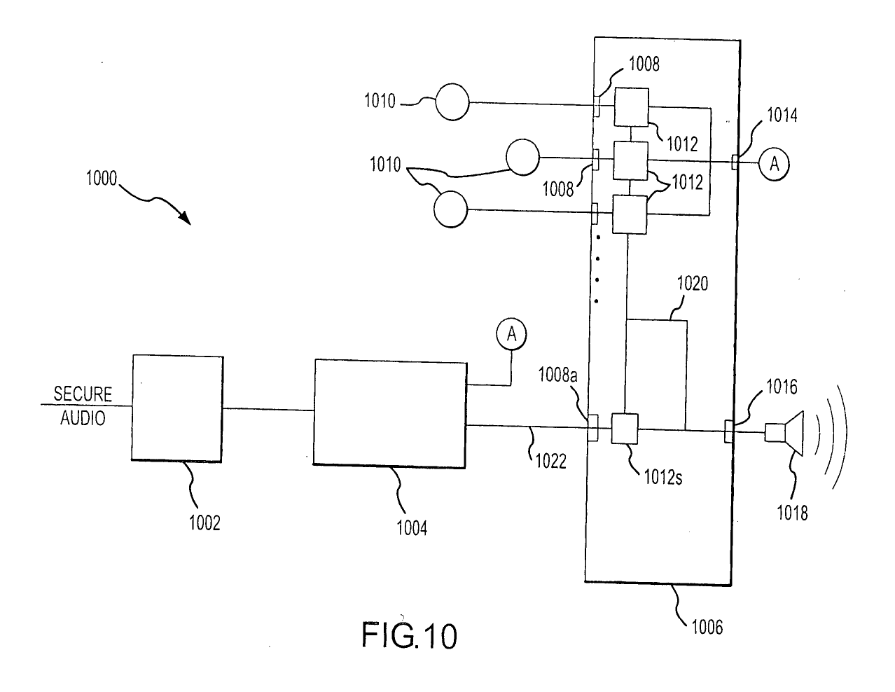

As shown above in FIG. 4, interface 400 includes side tone canceller 410. Side tone canceller 410 can be available from standard audio equipment, and interface 400 could access other available equipment. Referring now to FIG. 10, an audio conference system 1000 is described. FIG. 10 is described with respect to a secure telephone 1002, but one of ordinary skill in the art would recognize on reading the disclosure that other devices could be replaced for secure telephone 1002, such as, for example, a cellular telephone, a VoIP telephone, a conventional telephone, a satellite telephone or the like. Secure telephone 1002 is connected to an interface 1004 which is connected to the pre-wired audio conference room processor 1006. Audio conference room processor 1006 is a conventional device that will not be explained herein accept as it specifically relates to the present invention.

As shown, processor 1006 has a number of microphone input ports 1008 connected to a number of microphones 1010. Each input port is connected to an acoustic echo canceller 1012. The output of AEC 1012 are combined and output port 1014. A speaker output 1016 is connected to a speaker 1018. Feedback or echo from the speaker 1018 is cancelled from the microphone input by feeding back the speaker output over feedback line 1020 to AECs 1012, which cancel the echo in a conventional manner.

To connect a secure telephone, the decrypted plain audio signal 1022 can be routed from interface 1004 to one of the microphone inputs 1008a. The echo canceller attached to microphone input 1008a is converted to a side tone canceller 1012s. Thus, plain audio signal 1022 is broadcast over speaker 1018 and secure audio is transmitted to the remote secure telephone (not specifically shown in FIG. 10).

While the invention has been particularly shown and described with reference to embodiments thereof, it will be understood by those skilled in the art that various other changes in the form and details may be made without departing from the spirit and scope of the invention.

We claim:

1. An apparatus for connecting non-standard telecommunication signals to an audio conference system and for broadcasting audio from the audio conference system as a non-standard telecommunication signal, the apparatus comprising:
a telecommunications device;
the telecommunications device comprising an incoming transmission port to receive at least one non-standard telecommunication incoming transmission and convert the at least one non-standard telecommunication incoming transmission to an incoming audio signal;
a side tone canceller, the side tone canceller coupled to the telecommunications device and to a speaker of the audio conference system, the side tone canceller to receive the incoming audio signal and supplying a processed audio signal to the speaker, the side tone canceller including a feedback coupled to the processed audio signal to cancel the side tone; and
the telecommunication device comprising an outgoing transmission port to receive at least one return audio signal from the audio conference system and convert the at least one return audio signal to at least one non-standard telecommunication outgoing transmission.

2. The apparatus of claim 1, wherein the telecommunications device comprises a secure telephone, the at least one non-standard telecommunication incoming transmission comprises an incoming encrypted signal that is decrypted by the secure telephone to an audio signal, and the at least one non-standard telecommunication outgoing transmission comprises an outgoing encrypted signal that the secure telephone encrypts from the at least one return audio signal.

3. The apparatus of claim 1, wherein the telecommunications device comprises a cellular telephone, the at least one non-standard telecommunication incoming transmission comprises an incoming cellular signal that is converted to an audio signal, and the at least one non-standard telecommunication outgoing transmission comprises an outgoing cellular signal generated by the cellular telephone from the at least one return audio signal.

4. The apparatus of claim 1, wherein the telecommunications device comprises a VoIP telephone, the at least one non-standard telecommunication incoming transmission comprises an incoming VoIP signal that is converted to an audio signal, and the at least one non-standard telecommunication outgoing transmission comprises an outgoing VoIP signal generated by the VoIP telephone from the at least one return audio signal.

5. The apparatus of claim 1, wherein the telecommunications device comprises a satellite telephone, the at least one non-standard telecommunication incoming transmission comprises an incoming satellite signal that is converted to an audio signal, and the at least one non-standard telecommunication outgoing transmission comprises an outgoing satellite signal generated by the satellite telephone from the at least one return audio signal.

6. The apparatus of claim 1, further comprising a telecommunication device handset, the telecommunication device handset comprising a handset speaker and a handset microphone, the handset speaker broadcasts the at least one audio signal to a user and transmits at least one return audio signal from a user to the telecommunication device.

7. The apparatus of claim 6, further comprising a switch such that the telecommunication device handset is only in circuit when the switch is in a handset on position.

8. The apparatus of claim 7, wherein the audio conference system is only in circuit when the switch is in a handset off position.

9. The apparatus of claim 6, wherein the switch comprises at least one of an optical switch or a magnetic switch, and the switch has a default position.

10. The apparatus of claim 6, wherein the switch is a toggle switch.

11. The apparatus of claim 1, wherein:
the processed audio signal is transmitted to an audio conference processor that outputs the audio signal through the speaker to an audio conference room; and
the return audio signal is generated from a microphone and an acoustic echo canceller coupled to audio conference processor.

12. A method of connecting a non-standard telecommunications device to an audio conference system, the method comprising:
receiving a non-standard telecommunications incoming signal from a telecommunications network;
converting the non-standard telecommunications incoming signal to an incoming audio signal;
processing the incoming audio signal with a feedback signal to remove a side tone;
transmitting the incoming audio signal with the side tone removed to an audio conference room;
generating the feedback signal from the incoming audio signal transmitted to the audio conference room; and
broadcasting to the audio conference the incoming audio signal.

13. The method of claim 12, further comprising:
obtaining a return audio signal from a microphone in the audio conference room;
removing echoes generated by the microphone receiving the broadcast incoming audio signal;
converting the return audio signal into a non-standard telecommunications outgoing signal; and
transmitting the converted non-standard telecommunication outgoing signal over the telecommunications network.

14. The method of claim 12, wherein the converting step comprises decrypting the non-standard telecommunication incoming signal.

15. The method of claim 12, further comprising the step of switching between a handset and the audio conferencing system.

16. The method of claim 12, further comprising the step of connecting to the telecommunications network.

17. An audio conference system, comprising:
an audio conference room, the audio conference room comprising at least one room microphone and at least one room speaker;
at least one telecommunication device connected to a telecommunication network, the at least one telecommunication device to receive non-standard telecommunication incoming signals from and transmit non-standard telecommunication outgoing signals to the telecommunication network;
an audio conference room processor, the audio conference room processor comprising a plurality of signal input ports, a plurality of signal output ports, and a plurality of acoustic echo cancellers, the plurality of acoustic echo cancellers coupled to the signal input ports to cancel echo; and
an audio conference interface coupled to the at least one telecommunication device and to at least one of the plurality of signal input ports, such that
non-standard telecommunication incoming signals are converted to incoming audio signals that broadcast by the at least one room speaker and return audio signals from received by the at least one room microphone is converted to the non-standard telecommunication outgoing signals for transmission over the telecommunication network.

18. The audio conference system of claim 17, wherein the at least one telecommunication device comprises a secure telephone that decrypts non-standard telecommunication incoming signals and encrypts non-standard telecommunication outgoing signals.

19. The audio conference system of claim 17, wherein the at least one of the plurality of signal input ports associated with the at least one telecommunications device has an associated at least one acoustic echo canceller configured to cancel side tone.

20. The audio conference system of claim 17, wherein the at least one telecommunication device comprises a VoIP telephone that converts between non-standard telecommunication incoming signals and audio signals.

21. The audio conference system of claim 17, wherein the at least one telecommunication device comprises a cellular telephone that converts between non-standard telecommunication incoming signals and audio signals.

22. The audio conference system of claim 17, wherein the at least one telecommunication device comprises a satellite telephone that converts between non-standard telecommunication incoming signals and audio signals.

23. An apparatus to provide teleconferencing a plurality of non-standard telecommunication signals, the apparatus comprising:
at least one non-standard telecommunication device coupled to a corresponding telecommunication network, the at least one non-standard telecommunication device receives non-standard telecommunication incoming signals and converts the non-standard telecommunication incoming signals to incoming audio signals;
at least another telecommunication device, the at least another telecommunication device coupled to a corresponding telecommunication network, the at least another telecommunication device receives telecommunication incoming signals and converts the telecommunication incoming signals to incoming audio signals;
a processor, the processor comprising a plurality of inputs, the plurality of inputs connected to the at least one non-standard telecommunication device and the at least another telecommunication device to receive incoming audio signals, the processor comprising a plurality of outputs, the plurality of outputs connected to the at least one non-standard telecommunication device and the at least another telecommunication device, the processor receiving the incoming audio signals and generating outgoing audio signals,
the at least one non-standard telecommunication device receives the generated outgoing audio signals and converts the outgoing audio signals to non-standard telecommunication outgoing signals and transmits the non-standard telecommunication outgoing signal over the corresponding telecommunication network; and
the at least another telecommunication device receives the generated outgoing audio signals and converts the outgoing audio signals to a telecommunication outgoing signals and transmits the telecommunication outgoing signal over the corresponding telecommunication network.

24. The apparatus of claim 23, further comprising:
at least one remote non-standard telecommunication device coupled to the at least one non-standard telecommunication device over the corresponding telecommunication network; and
at least another remote telecommunication device coupled to the at least another telecommunication device over the corresponding telecommunication network, wherein
the at least one remote non-standard telecommunication device and the at least another remote telecommunication device can be in a telephone conference.

25. The apparatus of claim 23, wherein the at least one non-standard telecommunication device comprises a device selected from the group consisting of a secure telephone, a VoIP telephone, a cellular telephone, or a satellite telephone.

26. The apparatus of claim 23, wherein the at least one non-standard telecommunication device comprises a plurality of non-standard telecommunication devices.

27. The apparatus of claim 26, wherein the plurality of non-standard telecommunication devices comprise different non-standard telecommunication devices.

28. The apparatus of claim 23, wherein the at least another telecommunication device comprises another non-standard telecommunication device.

29. The apparatus of claim 28, wherein the another non-standard telecommunication device is different than the at least one non-standard telecommunication device.

30. The apparatus of claim 23, wherein the at least another telecommunication device comprises a plurality of telecommunication devices.

31. The apparatus of claim 23, further comprising:
a plurality of conference join switches; at least one of the plurality of conference join switches being associated with the at least one non-standard telecommunication device and the at least another telecommunication device to allow an operate to connect participants to a telephone conference.

32. The apparatus of claim 23, wherein at least one of the plurality of inputs and at least one of the plurality of outputs are connected to an audio conference room.
